(19) United States
(12) Patent Application Publication
(10) Pub. No.: US 2016/0377034 A1
(43) Pub. Date: Dec. 29, 2016

(54) COMPLEX HEAT EXCHANGER

(71) Applicant: HYUNDAI MOTOR COMPANY, Seoul (KR)

(72) Inventor: Jung Jae HAN, Yongin-si (KR)

(73) Assignee: HYUNDAI MOTOR COMPANY, Seoul (KR)

(21) Appl. No.: 14/942,253

(22) Filed: Nov. 16, 2015

(30) Foreign Application Priority Data
Jun. 26, 2015 (KR) 10-2015-0091357

(51) Int. Cl. F02M 26/30; F01M 5/02; F02M 26/32; F01M 5/00

(52) U.S. Cl. CPC F02M 26/30; F01M 5/001; F01M 5/021; F02M 26/32; F01M 2005/008

(57) ABSTRACT

A complex heat exchanger includes: a lower plate including a coolant inlet and a coolant outlet, an EGR gas inlet and an EGR gas outlet, and an oil inlet and an oil outlet. The inlets allow coolant, EGR gas, and oil to be introduced through the inlets, respectively, and the outlets allow the coolant, EGR gas, and oil to be discharged through them, respectively. The complex heat exchanger further includes a heat exchanging part stacked on top of the lower plate, and the heat exchanging part includes a coolant passage, an EGR gas passage, and an oil passage, which are separately formed in an interior of the heating exchanging part, allowing the coolant, the EGR gas, and the oil to separately flow while heating and cooling each other. An upper plate of the complex heat exchanger is coupled on top of the heat exchanging part.

### CROSS-REFERENCE TO RELATED APPLICATION

The present application claims the benefit of Korean Patent Application No. 10-2015-0091357, filed Jun. 26, 2015, which is incorporated herein by reference in its entirety.

### FIELD

The present disclosure generally relates to a heat exchanger able to simultaneously heat and cool a plurality of fluids.

### BACKGROUND

The statements in this section merely provide background information related to the present disclosure and may not constitute prior art.

An exhaust gas recirculation (EGR) cooler and an oil cooler are heat exchangers for engines. The EGR cooler is a device for reducing nitrogen oxides (NOx) by lowering the temperature of an EGR gas. The oil cooler is a device for cooling oil such that the temperature of the oil can remain at a suitable level.

Coolant (antifreeze) has a function in controlling the temperature of a fluid or a gas through heating and cooling in such a cooler. In particular, the coolant serves to maintain the temperature of oil at a certain level suitable for the operation of an engine. The oil is a lubricating element in a dynamic friction system that requires lubrication. Specifically, the oil is required for an oil pump of the engine, for the friction between a cylinder block and a piston, and most other parts of the engine. When the temperature of the oil is low, high kinematic viscosity of the oil increases the frictional force among these components. Therefore, during the operation of a vehicle, rapid increase of the temperature of the oil from a cold state may decrease the frictional force, thereby potentially improving the fuel efficiency of the vehicle.

The EGR cooler is a device for reducing exhaust (NOx). In the EGR cooler, the coolant lowers the temperature of hot EGR gas by absorbing heat from the EGR gas. While the coolant passes the oil cooler, the coolant transfers its heat energy to the oil of the oil cooler, and thus raises the temperature of the oil.

A heat source necessary to increase the temperature of the oil is combustion heat energy (including the heat of the EGR gas). Heat transferred from combustion gas can be regarded as the major heat source to increase the temperature of the coolant and the oil. Therefore, it is possible to increase the temperature of the coolant and the oil more rapidly using the heat of the engine by a variety of methods. Improved control over the temperatures of the EGR gas, the coolant, and the oil may contribute to the improved combustion efficiency and the enhanced fuel efficiency.

FIG. 1 is a schematic diagram illustrating an EGR cooler and an oil cooler of the related art.

As illustrated in FIG. 1, an EGR cooler 1 and an oil cooler 2 form separate cooling systems. EGR gas is discharged after being cooled through the EGR cooler 1 or bypasses the EGR cooler depending on the control of a valve 3. Coolant constantly flows through the EGR cooler 1, and after having flowed through the EGR cooler 1, flows to the oil cooler 2, thereby forming a cooling circuit.

An oil pump 4 takes oil and subsequently discharges the oil to the oil cooler 2. The oil is introduced to and cooled in the oil cooler 2. Thereafter, the oil passes through an oil filter 5 and subsequently flows to a device 6 requiring lubrication, thereby forming a lubrication circuit.

The EGR cooler 1 and the oil cooler 2 heat and cool each other in an indirect manner via coolant. However, a significant amount of time is consumed to raise the temperature of the oil in the cold state, and the discharge pressure of the oil pump 4 is increased. As a result, the pressure of the oil is increased, the bearing pressure of a friction system is increased, and thus the frictional force of a driving system is increased, which are problematic. Cold oil forms a high level of kinematic viscosity and a high oil pressure, thereby decreasing the wear resistance of engine components and causing noise. Consequently, cold oil reduces the endurance of the engine.

### SUMMARY

The present disclosure proposes a complex heat exchanger, the size of which can be reduced by integrating an exhaust gas recirculation (EGR) cooler and an oil cooler. The complex heat exchanger is configured to rapidly increase the temperature of oil to reduce friction in the operation of an engine, thereby improving fuel efficiency.

One aspect of the present disclosure provides a complex heat exchanger including: a lower plate having a coolant inlet, an EGR gas inlet, and an oil inlet on one portion and a coolant outlet, an EGR gas outlet, and an oil outlet on the other portion of the lower plate, wherein the coolant inlet, the EGR gas inlet, and the oil inlet, each of which allow coolant, EGR gas and oil flows in, and the coolant outlet, the EGR gas outlet and the oil outlet, each of which allow the coolant, EGR gas and oil to be discharged; a heat exchanging part stacked on top of the lower plate, the heating exchanging part having a coolant passage, an EGR gas passage, and an oil passage separately formed in an interior of the heating exchanging part, allowing the coolant, the EGR gas, and the oil to separately flow while heating and cooling each other; and an upper plate coupled on top of the heat exchanging part.

The heat exchanging part may include a plurality of coolant plates, a plurality of EGR gas plates, and a plurality of oil plates, each of which is open at a front side and is recessed in a rearward direction.

The plurality of coolant plates, the plurality of EGR gas plates, and the plurality of oil plates may be alternately and sequentially stacked on the lower plate, thereby forming a coolant passage, an EGR gas passage, and an oil passage through which the coolant, the EGR gas, and the oil separately flow.

Each of the plurality of coolant plates may have coolant flow holes in positions corresponding to the coolant inlet and the coolant outlet. Each of the plurality of EGR gas plates may have EGR gas flow holes in positions corresponding to the EGR gas inlet and the EGR gas outlet. Each of the plurality of oil plates may have oil flow holes in positions corresponding to the oil inlet and the oil outlet.

The coolant passage may communicate with the coolant flow holes. The EGR gas passage may communicate with the EGR gas flow holes. The oil passage may communicate with the oil flow holes. The coolant passage, the EGR gas passage, and the oil passage may be formed separately from each other.

Each of the plurality of coolant plates, the plurality of EGR gas plates, and the plurality of oil plates may have a plurality of concaves and convexes that increase an area contacting a corresponding one of the coolant, the EGR gas, and the oil.

Each of the plurality of coolant plates, the plurality of EGR gas plates, and the plurality of oil plates may include a copper (Cu) coating layer on an underside surface thereof in order to improve efficiency of heat transfer.

According to forms of the present disclosure, it is possible to reduce the size of the heat exchanger by integrating an EGR cooler and an oil cooler that are separate parts in the related art. This can contribute to the reduced weight of a vehicle, thereby improving the fuel efficiency of the vehicle.

In addition, it is possible to reduce the amount of nitrogen oxides (NOx) by cooling EGR gas rapidly, thereby preventing air pollution. Since the temperature of the oil is rapidly increased, the friction in the operation of the engine is reduced, thereby improving the fuel efficiency of the vehicle.

Furthermore, it is possible to improve the efficiency of heat exchange by coating the underside surface of each of the coolant, oil, and EGR gas plates with Cu.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic diagram illustrating an EGR cooler and an oil cooler of the related art;

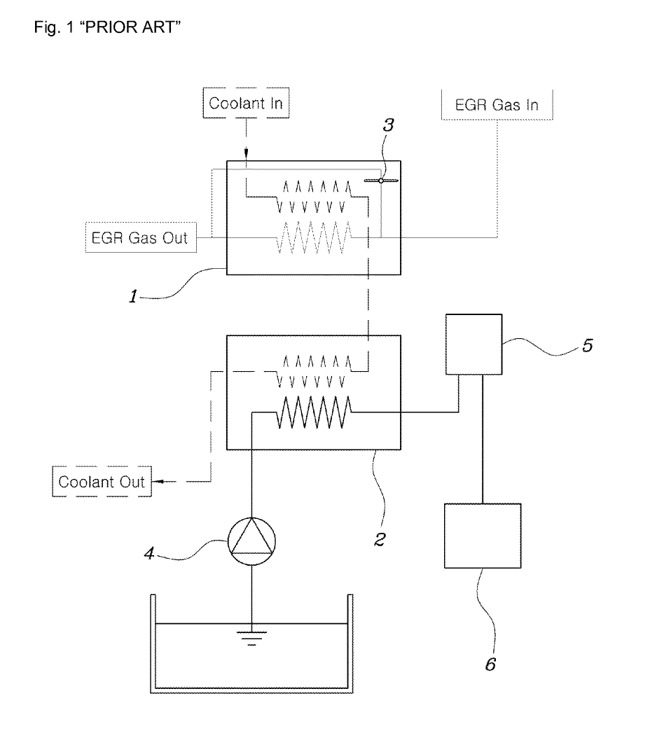

FIG. 2 is a schematic diagram illustrating a complex heat exchanger;

FIG. 3 is a cross-sectional view illustrating the complex heat exchanger; and

FIG. 4 illustrates a process of forming a copper coating layer employed in the complex heat exchanger.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

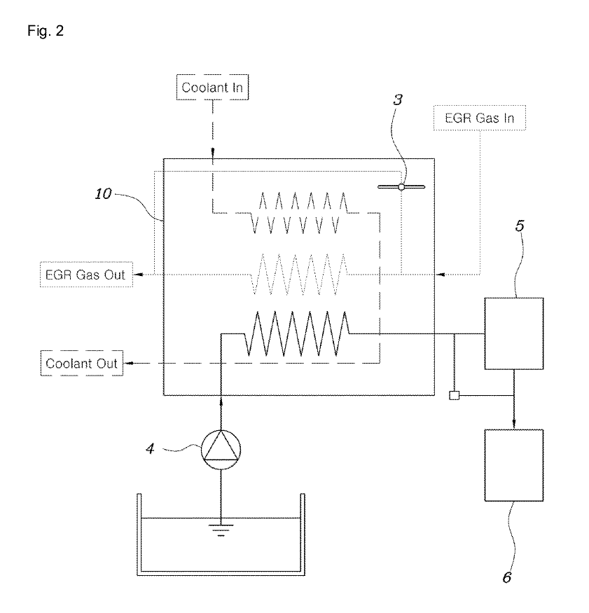

Referring to FIG. 2, a complex heat exchanger 10 according to the exemplary form of the present disclosure may reduce the size by combining an exhaust gas recirculation (EGR) cooler and an oil cooler that have been separate components in the related art while improving heat exchange efficiency.

The complex heat exchanger 10 enables oil, EGR gas, and coolant to simultaneously circulate within the complex heat exchanger 10 while heating and cooling each other (by heat exchange). In this manner, the complex heat exchanger 10 can reduce the nitrogen oxides (NOx) by rapidly cooling the EGR gas and improve the fuel efficiency of a vehicle by rapidly raising the temperature of the oil.

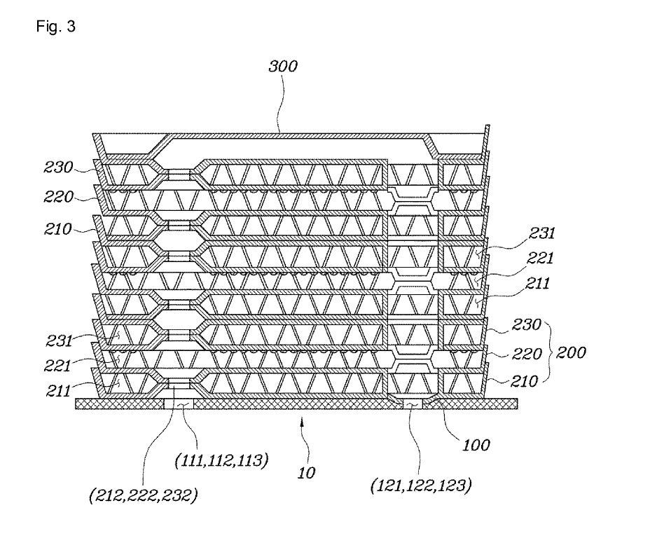

FIG. 3 is a cross-sectional view illustrating the complex heat exchanger according to the exemplary form of the present disclosure.

As illustrated in FIG. 3, the complex heat exchanger according to the exemplary form of the present disclosure includes an upper plate 300, a lower plate 100, and a heat exchanging parts 200 comprising a plurality of plates stacked one on another between the upper plate 300 and the lower plate 100.

A coolant inlet 111 through which coolant is introduced, an EGR gas inlet 112 through which EGR gas is introduced, and an oil inlet 113 through which oil is introduced, are disposed on one side of the lower plate 100. A coolant outlet 121 through which the coolant is discharged, an EGR gas outlet 122 through which the EGR gas is discharged, and an oil outlet 123 through which the oil is discharged, are disposed on the other side of the lower plate, in correspondence to the coolant inlet 111, the EGR gas inlet 112, and the oil inlet 113, respectively.

With this configuration, the coolant, the EGR gas, and the oil are introduced to the interior of the heat exchanger 200 through the coolant inlet 111, the EGR gas inlet 112, and the oil inlet 113, and the coolant, the EGR gas, and the oil separately flow through the interior of the heat exchanger 200 while heating and cooling each other (by heat exchange), and subsequently are discharged through the coolant outlet 121, the EGR gas outlet 122, and the oil outlet 123.

The exchanging part 200 includes a plurality of coolant plates 210, a plurality of EGR gas plates 220, and a plurality of oil plates 230 that are alternately and sequentially stacked one on another.

Each of the plurality of coolant plates 210, the plurality of EGR gas plates 220, and the plurality of oil plates 230 is open at the front side and is recessed in the rearward direction. The plurality of coolant plates 210, the plurality of EGR gas plates 220, and the plurality of oil plates 230 are alternately and sequentially stacked between the lower plate 100 and the upper plate 300, thereby forming a coolant passage 211, an EGR gas passage 221, and an oil passage 231, such that the coolant, the EGR gas, and the oil can respectively flow through the interiors thereof.

In addition, a first coolant plate 210 among the plurality of coolant plates 210 is stacked on top of the lower plate 100, and a first EGR gas plate 220 among the EGR gas plates 220 is stacked on top of the first coolant plate 210, whereby a first portion of the coolant passage 211 through which the coolant flows, is formed between the coolant plates 210 and the EGR gas plates 220.

Furthermore, a first oil plate 230 among the plurality of oil plates 230 is stacked on top of the first EGR gas plate 220. As in the coolant passage, a first portion of the EGR gas passage 221 (i.e. a space through the EGR gas flows) is formed between the first EGR gas plate 220 and the first oil plate 230. Sequentially, a second coolant plate 210 among the plurality of coolant plates 210 is stacked on top of the first oil plate 230, thereby forming a first portion of the oil passage 231 between the first oil plate 230 and the second coolant plate 210.

The plurality of coolant plates 210, the plurality of EGR gas plates 220, and the plurality of oil plates 230 are sequentially stacked one on another as described above, thereby alternately and sequentially forming the coolant passage 211, the EGR gas passage 221, and the oil passage 231, through which the coolant, the EGR gas, and the oil can simultaneously heat and cool each other.

This feature can reduce the size of the heat exchanger by combining the EGR cooler and the oil cooler while improving heat exchange efficiency.

Each of the coolant plates 210 has coolant flow holes 212 in positions corresponding to the coolant inlet 111 and the coolant outlet 121. The coolant flow holes 212 communicate with the coolant passage 211, i.e., the portions of the coolant passage 211 are connected to each other via the coolant flow holes 212.

As in the coolant plate 210, each of the EGR gas plates 220 has EGR gas flow holes 222 in positions corresponding to the EGR gas inlet 112 and the EGR gas outlet 122. The portions of the EGR gas passage 221 are connected via the EGR gas flow holes 222. In addition, each of the oil plates 230 has oil flow holes 232 in positions corresponding to the oil inlet 113 and the oil outlet 123. The portions of the oil passage 231 are connected via the oil flow holes 232. Accordingly, the respective fluids (i.e., the coolant, the EGR gas, and the oil) heat and cool each other while separately flowing.

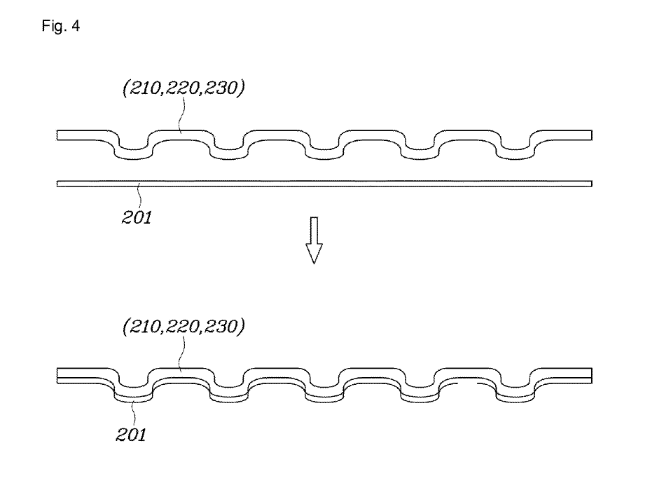

In one form, each of the coolant plates 210, the EGR gas plates 220, and the oil plates 230 may have a plurality of concave and convex portions (213, 223, and 233 in FIG. 4). The plurality of concave and convex portions 213, 223, and 233 may increase surface areas that contact the fluids, thereby improving the efficiency of heat exchange.

FIG. 4 illustrates a process of forming a copper coating layer employed in the complex heat exchanger according to the exemplary form of the present disclosure.

As illustrated in FIG. 4, in one form of the present disclosure, each of the coolant plates 210, the EGR gas plates 220, and the oil plates 230 may further have a copper (Cu) coating layer 201 on the underside surface thereof. The Cu coating layer 201 is formed by placing a Cu sheet on the underside surface of each of the coolant plates 210, the EGR gas plates 220, and the oil plates 230 and brazing the Cu sheet thereto.

When the heat exchanging part 200 is formed by sequentially stacking the coolant plates 210, the EGR gas plates 220, and the oil plates 230 one on another, the coolant plates 210, the EGR gas plates 220, and the oil plates 230 can be brazed with each other more easily, thereby facilitating assembling operations. This also increases bonding force and improves the efficiency of heat transfer, thereby further improving the efficiency of heat exchange.

Although the exemplary forms of the present disclosure have been described for illustrative purposes, a person skilled in the art will appreciate that various modifications, additions and substitutions are possible, without departing from the scope and spirit of the present disclosure as disclosed in the accompanying claims.

What is claimed is:

1. A complex heat exchanger comprising:
a lower plate including:
a coolant inlet and an coolant outlet through which a coolant flows in and out,
an EGR gas inlet and an EGR gas outlet through which a EGR gas flows in and out, and
an oil inlet and an oil outlet through which an oil flows in and out;
a heat exchanging part stacked on a top of the lower plate, the heating exchanging part including: a coolant passage, an EGR gas passage, and an oil passage, which are separately formed in an interior of the heating exchanging part, wherein the coolant, EGR gas and oil passages are configured to separately flow the coolant, the EGR gas, and the oil while heating and cooling each other; and
an upper plate coupled on a top of the heat exchanging part.

2. The complex heat exchanger according to claim 1, wherein the heat exchanging part comprises a plurality of coolant plates, a plurality of EGR gas plates, and a plurality of oil plates, each of which is open at a front side and is recessed in a rearward direction,
wherein the plurality of coolant plates, EGR gas plates and oil plates are alternately and sequentially stacked on the lower plate, thereby forming a coolant passage, an EGR gas passage, and an oil passage along which the coolant, the EGR gas, and the oil separately flow.

3. The complex heat exchanger according to claim 2, wherein each of the coolant plates includes coolant flow holes in positions corresponding to the coolant inlet and the coolant outlet, each of the EGR gas plates includes EGR gas flow holes in positions corresponding to the EGR gas inlet and the EGR gas outlet, and each of the oil plates includes oil flow holes in positions corresponding to the oil inlet and the oil outlet.

4. The complex heat exchanger according to claim 3, wherein the coolant passage communicates with the coolant flow holes, the EGR gas passage communicates with the EGR gas flow holes, the oil passage communicates with the oil flow holes, and the coolant passage, the EGR gas passage, and the oil passage are formed separately from each other.

5. The complex heat exchanger according to claim 2, wherein each of the coolant plates, the EGR gas plates, and the oil plates includes a plurality of concaves and convexes that are configured to increase an area contacting a corresponding one of the coolant, the EGR gas, and the oil.

6. The complex heat exchanger according to claim 2, wherein each of the coolant plates, the EGR gas plates, and the oil plates comprises a copper coating layer on an underside surface thereof configured to improve of a heat transfer.
